(19) United States
(12) Patent Application Publication
(10) Pub. No.: US 2022/0189096 A1
(43) Pub. Date: Jun. 16, 2022

(54) OPACITY TEXTURE-DRIVEN TRIANGLE SPLITTING

(71) Applicant: Advanced Micro Devices, Inc., Santa Clara, CA (US)

(72) Inventors: Ruijin Wu, San Diego, CA (US); Sagar S. Bhandare, San Diego, CA (US); Young In Yeo, San Diego, CA (US); Skyler Jonathon Saleh, San Diego, CA (US)

(73) Assignee: Advanced Micro Devices, Inc., Santa Clara, CA (US)

(21) Appl. No.: 17/118,549

(22) Filed: Dec. 10, 2020

(51) Int. Cl. G06T 15/06; G06T 15/00; G06T 17/00

(52) U.S. Cl. CPC G06T 15/06; G06T 2210/12; G06T 17/005; G06T 15/005

(57) ABSTRACT

Techniques for performing ray tracing operations are provided. The techniques include dividing a primitive of a scene to generate primitive portions; identifying, from the primitive portions, and based on an opacity texture, one or more opaque primitive portions and one or more invisible primitive portions; generating box nodes for a bounding volume hierarchy corresponding to the opaque primitive portions, but not the invisible primitive portions; and inserting the generated box nodes into the bounding volume hierarchy.

### BACKGROUND

Ray tracing is a type of graphics rendering technique in which simulated rays of light are cast to test for object intersection and pixels are colored based on the result of the ray cast. Ray tracing is computationally more expensive than rasterization-based techniques, but produces more physically accurate results. Improvements in ray tracing operations are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure are implemented;

FIG. 2 illustrates details of the device of FIG. 1, according to an example;

FIG. 3 illustrates a ray tracing pipeline for rendering graphics using a ray tracing technique, according to an example;

FIG. 4 is an illustration of a bounding volume hierarchy, according to an example;

FIG. 5 illustrates an example technique showing application of an opacity texture to a primitive;

FIG. 6 illustrates an example application of the technique for applying an opacity texture to a primitive in the context of ray tracing;

FIG. 7 illustrates an example technique for subdividing primitives with an opacity texture to reduce the effective portion of the primitives that result in a hit;

FIG. 8 illustrates an example technique for building a bounding volume hierarchy (“BVH”) based on the primitive subdivision technique of FIG. 7; and

FIG. 9 is a flow diagram of a method for performing ray tracing operations, according to an example.

### DETAILED DESCRIPTION

Techniques for performing ray tracing operations are provided. The techniques include dividing a primitive of a scene to generate primitive portions; identifying, from the primitive portions, and based on an opacity texture, one or more opaque primitive portions and one or more invisible primitive portions; generating box nodes for a bounding volume hierarchy corresponding to the opaque primitive portions, but not the invisible primitive portions; and inserting the generated box nodes into the bounding volume hierarchy.

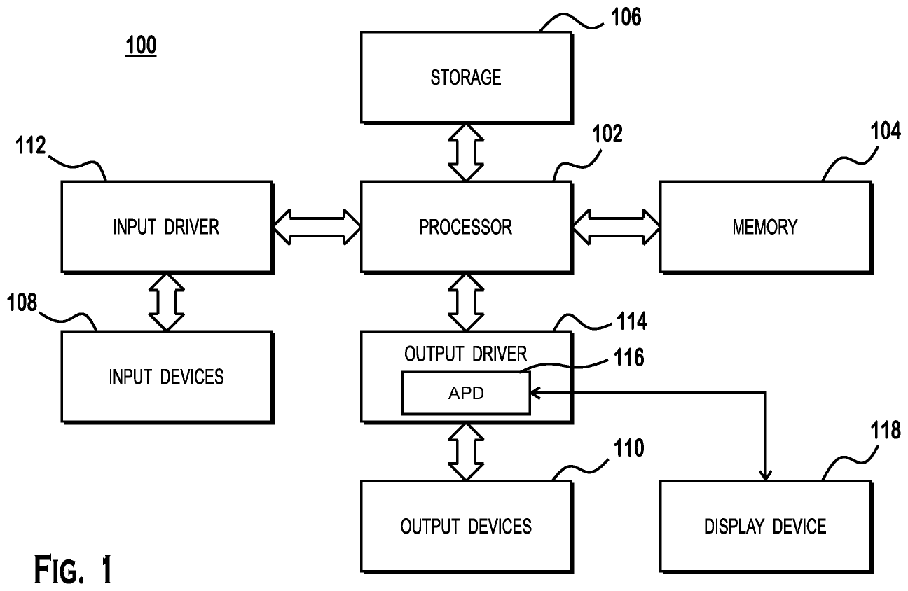

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein, in different implementations, each processor core is a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (“APD”) 116 which is coupled to a display device 118, which, in some examples, is a physical display device or a simulated device that uses a remote display protocol to show output. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated for any processing system that performs processing tasks in accordance with a SIMD paradigm to be configured to perform the functionality described herein. Alternatively, it is contemplated that computing systems that do not perform processing tasks in accordance with a SIMD paradigm performs the functionality described herein.

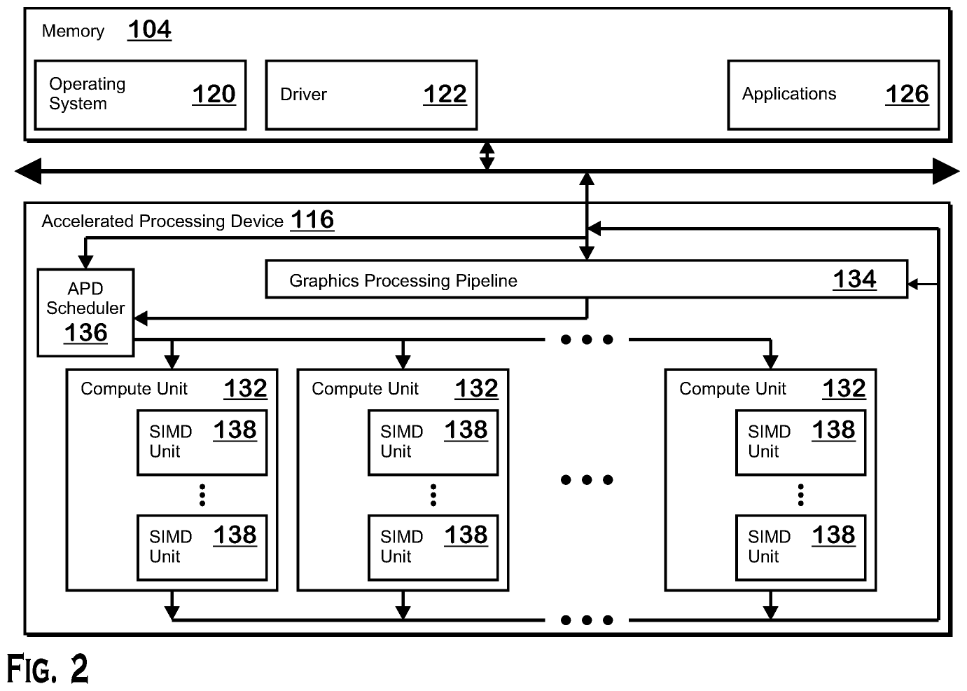

FIG. 2 illustrates details of the device 100 and the APD 116, according to an example. The processor 102 (FIG. 1) executes an operating system 120, a driver 122, and applications 126, and also, in some situations, executes other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that are suited for parallel processing. In various examples, the APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102. In some examples, these compute processing operations are performed by executing compute shaders on the SIMD units 138.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but is able to execute that instruction with different data. In some situations, lanes are switched off with predication if not all lanes need to execute a given instruction. In some situations, predication is also used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. In various examples, work-items are executed simultaneously (or partially simultaneously and partially sequentially) as a “wavefront” on a single SIMD processing unit 138. One or more wavefronts are included in a “work group,” which includes a collection of work-items designated to execute the same program. In some implementations, a work group is executed by executing each of the wavefronts that make up the work group. In alternatives, the wavefronts are executed on a single SIMD unit 138 or on different SIMD units 138. In some implementations, wavefronts are the largest collection of work-items that are executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD scheduler 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The APD 116, including the compute units 132, implements ray tracing, which is a technique that renders a 3D scene by testing for intersection between simulated light rays and objects in a scene. In some implementations, much of the work involved in ray tracing is performed by programmable shader programs, executed on the SIMD units 138 in the compute units 132, as described in additional detail below.

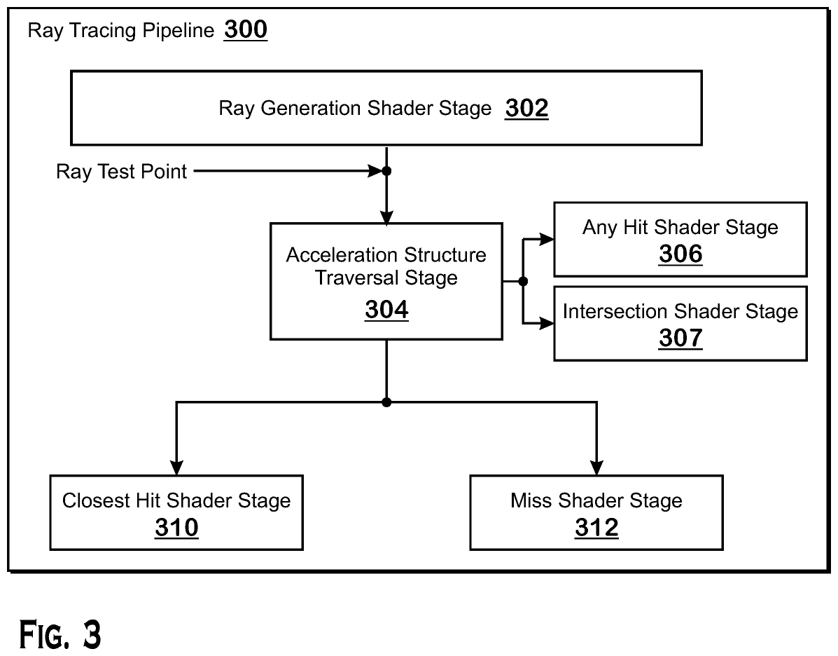

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, intersection shader 307, closest hit shader 310, and miss shader 312 are, in some implementations, shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs the ray intersection test to determine whether a ray hits a triangle. The other programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The ray tracing pipeline 300 is, in various implementations, orchestrated partially or fully in software or partially or fully in hardware, and, in various implementations, is orchestrated by the processor 102, the scheduler 136, by a combination thereof, or partially or fully by any other hardware and/or software unit.

In examples, traversal through the ray tracing pipeline 300 is performed partially or fully by the scheduler 136, either autonomously or under control of the processor 102, or partially or fully by a shader program (such as a bounding volume hierarchy traversal shader program) executing on one or more of the SIMD units 138. In some examples, testing a ray against boxes and triangles (inside the acceleration structure traversal stage 304) is hardware accelerated (meaning that a fixed function hardware unit performs the steps for those tests). In other examples, such testing is performed by software such as a shader program executing on one or more SIMD units 138. Herein, where the phrase “the ray tracing pipeline does [a thing]” is used, this means that the hardware and/or software that implements the ray tracing pipeline 300 does that thing. Although described as executing on the SIMD unit 138 of FIG. 3, it should be understood that in other implementations, other hardware (such as one or more processors), having or not having SIMD capabilities (e.g., the processor 102), alternatively executes the shader programs of the illustrated ray tracing pipeline 300.

In some modes of operation, the ray tracing pipeline 300 operates in the following manner. A ray generation shader 302 is executed. The ray generation shader 302 sets up data for a ray to test against a triangle or scene that includes a collection of triangles and requests the acceleration structure traversal stage 304 test the ray for intersection with triangles.

The acceleration structure traversal stage 304 traverses an acceleration structure, which is a data structure that describes a scene and objects within the scene, and tests the ray against triangles in the scene. In some examples, during this traversal, for triangles that are intersected by the ray, the ray tracing pipeline 300 triggers execution of an any hit shader 306 and/or an intersection shader 307 if those shaders are specified by the material of the intersected triangle. Note that multiple triangles can be intersected by a single ray. It is not guaranteed that the acceleration structure traversal stage will traverse the acceleration structure in the order from closest-to-ray-origin to farthest-from-ray-origin. In some examples, the acceleration structure traversal stage 304 triggers execution of a closest hit shader 310 for the triangle closest to the origin of the ray that the ray hits, or, if no triangles were hit, triggers a miss shader.

Note, it is possible for the any hit shader 306 or intersection shader 307 to “reject” an intersection from the acceleration structure traversal stage 304, and thus the acceleration structure traversal stage 304 triggers execution of the miss shader 312 if no intersections are found to occur with the ray or if one or more intersections are found but are all rejected by the any hit shader 306 and/or intersection shader 307. An example circumstance in which an any hit shader 306 “rejects” a hit is when at least a portion of a triangle that the acceleration structure traversal stage 304 reports as being hit is fully transparent (“invisible”). In an example, the acceleration structure traversal stage 304 tests geometry and not transparency. Thus, in these examples, the any hit shader 306 that is invoked due to an intersection with a triangle having at least some transparency sometimes determines that the reported intersection should not count as a hit due to “intersecting” a transparent portion of the triangle. A typical use for the closest hit shader 310 is to color a ray based on a texture for the material. A typical use for the miss shader 312 is to color a ray with a color set by a skybox. It should be understood that, in various implementations, the shader programs defined for the closest hit shader 310 and miss shader 312 implements a wide variety of techniques for coloring ray and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. It is possible for multiple rays to be cast per pixel, with the final color of the pixel being determined by some combination of the colors determined for each of the rays of the pixel.

It is possible for any of the any hit shader 306, intersection shader 307, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 are used to render a scene have been described, any of a wide variety of techniques are alternatively used.

As described above, the determination of whether a ray intersects an object is referred to herein as a “ray intersection test.” The ray intersection test involves shooting a ray from an origin and determining whether the ray intersects a geometric primitive (e.g., a triangle) and, if so, what distance from the origin the triangle intersection is at. For efficiency, the ray tracing test uses a representation of space referred to as an acceleration structure, such as a bounding volume hierarchy. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each typically represent different axis aligned bounding boxes that subdivide the entire region. Each of those two children has two child nodes that represent axis aligned bounding boxes that subdivide the space of their parents, and so on. Leaf nodes represent a triangle or other geometric primitive against which a ray intersection test is performed. A non-leaf node is sometimes referred to as a “box node” herein and a leaf node is sometimes referred to as a “triangle node” herein.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box are eliminated from the test. Thus, a ray intersection test is performed as a sequence of tests of the ray against axis-aligned bounding boxes, followed by tests against triangles.

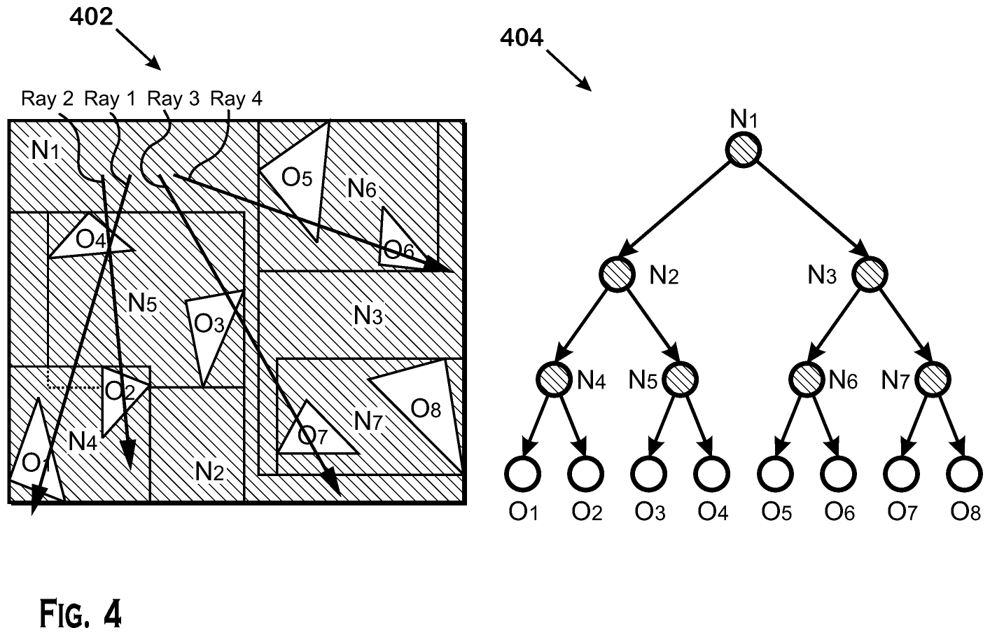

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “0” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

It is possible to render a geometrically complex object by representing that object by a large number of detailed polygons. An alternative technique is a technique in which simple geometry, such as a single primitive, is rendered with an opacity texture that indicates which portions of that primitive are considered opaque and which portions are considered invisible. This alternative technique has the benefit that a much smaller amount of geometry is processed.

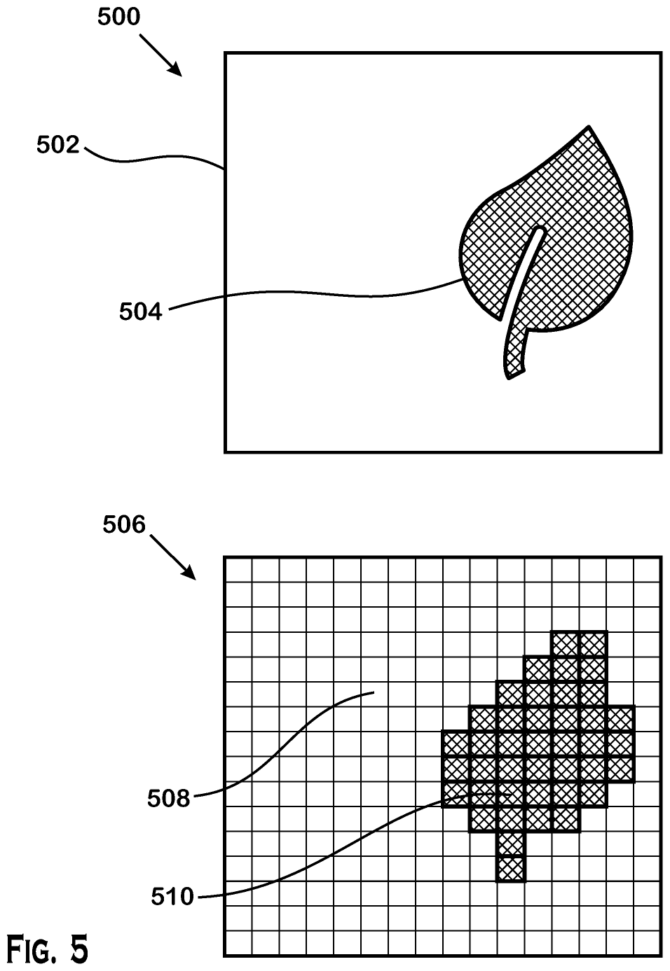

FIG. 5 illustrates an example technique 500 showing application of an opacity texture 504 to a primitive 502. The primitive in this figure is a quad (a quadrilateral primitive), but the technique is applicable to any other primitive. The opacity texture 504, which is applied to the primitive 502, indicates which portion of the primitive 502 is opaque and which portion of the primitive 502 is invisible. Specifically, the portion of the quad 502 that is within the leaf shape is opaque and the portion of the quad 502 that is external to the leaf shape is invisible.

In a corresponding rendered image 506, colored pixels 510 corresponding to the leaf are shown, and empty pixels 508 are shown for the portions outside of the leaf. Rendering the primitive 502 with the opacity texture 504 results in pixels 508 corresponding to the opaque portions of the primitive 502, but no pixels corresponding to the invisible portions 510 of the primitive 502. The portions of the render target corresponding to the empty pixels 508 might be colored by other rendering.

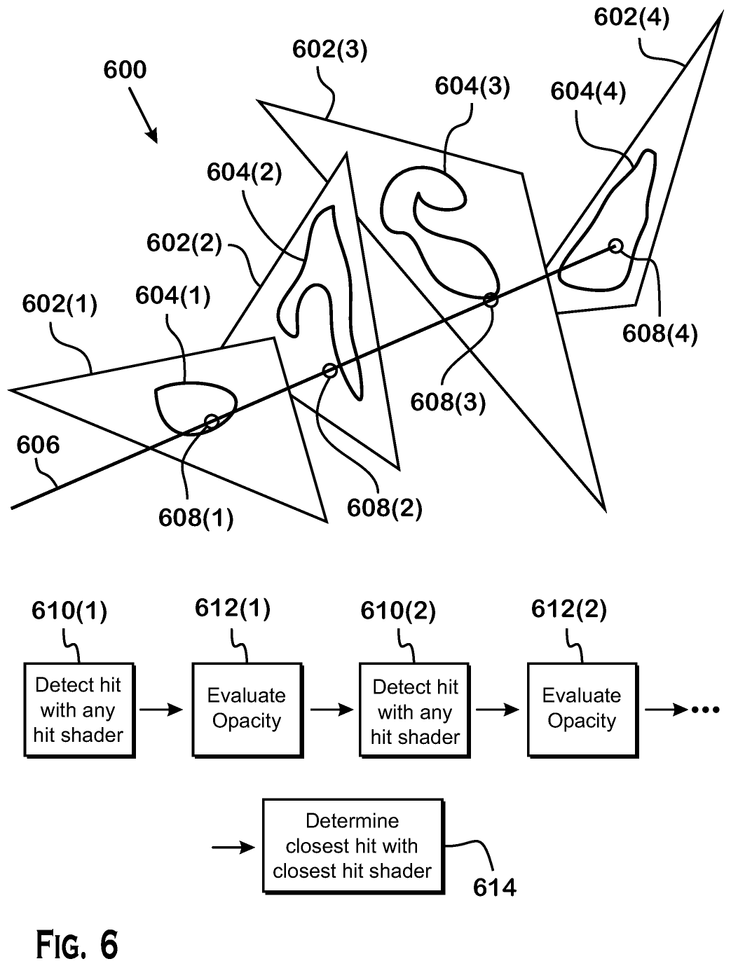

FIG. 6 illustrates an example application 600 of the technique for applying an opacity texture to a primitive in the context of ray tracing. Several primitives 602 are shown, and several opacity textures 604 indicating opaque areas are shown. A ray 606 that is cast is illustrated as intersecting each primitive 602. The intersection points 608 between the ray 606 and the primitives 602 are shown as well.

In the example application, the ray tracing pipeline 300 casts the ray to determine what color to display for the ray. To make this determination, the ray tracing pipeline 300 executes an any hit shader 306 to identify 610 all hits with primitives 602. For each such hit, the ray tracing pipeline 300 (e.g., within the any hit shader 306) evaluates whether the position of the hit in the opacity texture is considered opaque or invisible 612. After all hits on primitives have been identified with the any hit shaders 306 and opacity has been evaluated for each such hit primitive, a closest hit shader 310 examines the group of hit primitives for which the hit is opaque to determine which such hit is the closest hit 614. Then, the closest hit shader 310 determines a color for that hit (which can be done through any technically feasible means such as applying a texture and lighting and performing other steps).

The above technique for determining a closest hit for primitives that have an opacity texture is a fairly expensive in terms of processing time. For example, multiple instances of the any hit shader 306 are executed. Thus, reducing the number of instances of the any hit shader 306 that are executed would improve performance.

It is possible that the portion of a particular primitive 602 that is considered opaque by the opacity texture 604 is sometimes quite small. For instance, in primitive 602(1), only a central region is considered opaque. Similarly, for the other illustrated primitives 602 of FIG. 6, the portions of those primitives 602 that are opaque are a good deal smaller than the total area of the primitive 602. Thus, a technique is presented herein to generate a bounding volume hierarchy that results in fewer any hit shader executions by reducing the effective portion of the primitives 602 that result in a hit.

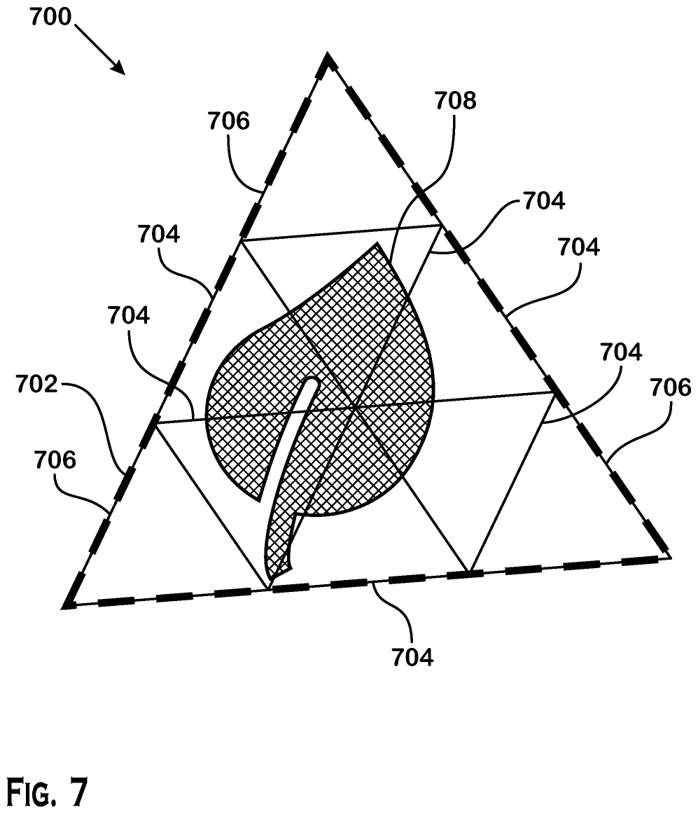

FIG. 7 illustrates an example technique for subdividing primitives with an opacity texture to reduce the effective portion of the primitives that result in a hit. The primitive 700 is shown, with an opacity texture 708 applied. The primitive 700 is divided into multiple sub-primitives, including opaque primitive portions 704 and invisible primitive portions 706. The opaque primitive portions 704 are portions of the primitive 700 that are overlapped by an opaque portion of the opacity texture 708. The invisible portions are portions of the primitive 700 that are not overlapped by an opaque portion of the opacity texture 708. Note that if only the opaque primitive portions 704 are considered during a ray tracing operation, then the number of hits detected during any hit shader executions is reduced. For example, a ray that would intersect the bottom right corner of the primitive 700 does not intersect the corresponding invisible primitive portion 706.

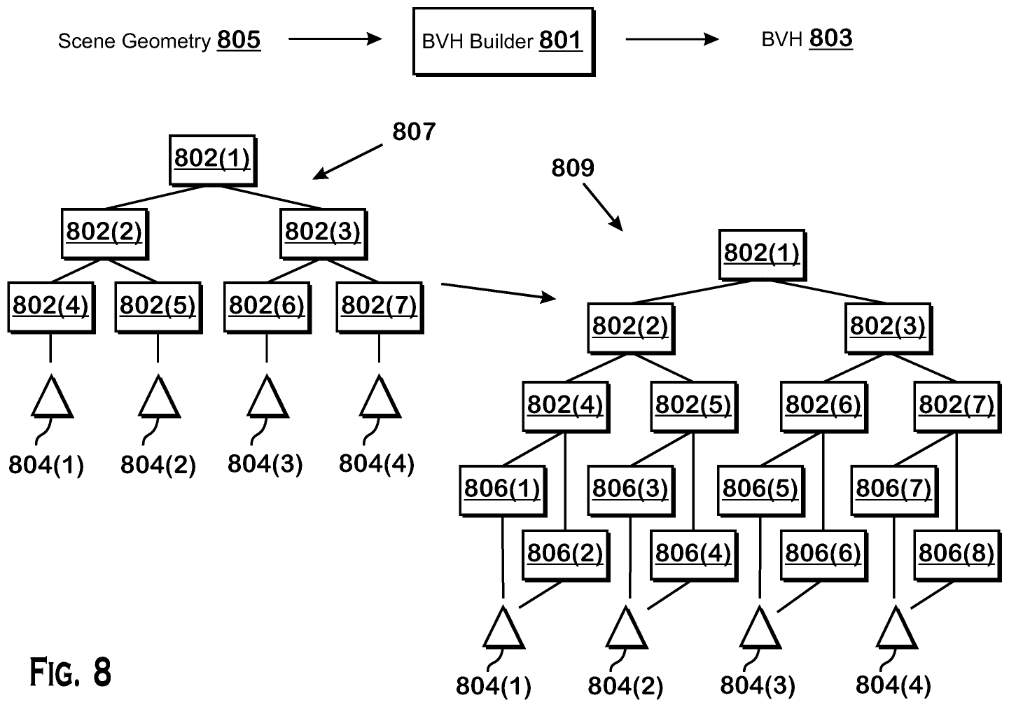

FIG. 8 illustrates an example technique for building a bounding volume hierarchy (“BVH”) based on the primitive subdivision technique of FIG. 7. A BVH builder 801 builds a BVH 803 from scene geometry 805. The BVH builder 801 is implemented as software executing on a processor configured to perform the functionality described herein, hard-wired circuitry configured to perform the functionality described herein, or a combination of software executing on a processor and hard-wired circuitry that together are configured to perform the functionality described herein. In various examples, the BVH builder 801 is in a computer system (e.g., computer system 100), such as executing on the processor 102 or the APD 116, or is a hardware unit in the processor 102 or APD 116. In various examples, the BVH builder 801 builds the BVH at compile time, on a different computer system than the computer system that performs ray tracing using the built BVH to render a scene. In other examples, the BVH builder 801 builds the BVH at runtime, on the same computer that renders the scene using ray tracing techniques. In various examples, a driver, an application, or a hardware unit of the APD 116 performs this runtime rendering.

The BVH builder 801 accepts scene geometry 805 and generates a bounding volume hierarchy 803. The scene geometry 805 includes primitives that describe a scene, which is provided by an application or other entity. The bounding volume hierarchy (“BVH”) 803 is similar to the bounding volume hierarchy 404 of FIG. 4. Specifically, the BVH 803 includes non-leaf nodes (sometimes referred to herein as box nodes) and leaf nodes. A box node is associated with geometry (such as axis-aligned bounding boxes) that fully enclose the geometry below the box node. A leaf node is associated with a specific primitive of the scene geometry 805.

Referring to FIGS. 7 and 8 together, the BVH builder 801 generates an initial BVH 807 that does not include split triangles of FIG. 7. More specifically, each leaf node is associated with a primitive of the scene geometry 805, but there are no leaf nodes that represent an opaque primitive portion 704 that is a subdivision of one of the scene primitives.

The BVH builder 801 uses any technically feasible technique to generate the initial BVH 807. In an example, the BVH builder 801 builds the initial BVH 807 by iteratively geometrically subdividing the geometry of the scene (e.g., by bisecting the bounding box of the scene along a particular axis). Each subdivision results in a different bounding box, which the BVH builder 801 sets as a box node 802. The BVH builder 801 uses certain criteria, such as a maximum number of primitives in a box node 802 or a maximum depth in the BVH 807, to determine which box nodes 802 the leaf nodes 804 are parented to. For example, the BVH builder 801 makes a box node 802 whose bounding box contains a maximum of two primitives the parent of the leaf nodes 804 for those two primitives. The result is a set of box nodes 802, each of which points to either one or more other box nodes 802 or one or more other triangle nodes 804 as illustrated.

The BVH builder 801 generates a refined BVH 809 in the following manner. The BVH builder 801 examines one or more primitives associated with the leaf noes 804 of the initial BVH 807. The BVH builder 801 divides the primitives associated with one or more such leaf nodes 804 into smaller primitives as shown in FIG. 7. The BVH builder 801 uses any technically feasible technique to divide these primitives into smaller primitives. In an example, the BVH builder 801 repeatedly bisects a triangle primitive with a line between a vertex of the triangle and an opposing edge. In another example, the BVH builder 810 tessellates the primitive, replacing the primitive by a plurality of similarly-shaped primitives. In general, the BVH builder 801 replaces a primitive with multiple primitives that together occupy the same area as the replaced primitive.

To generate the refined BVH 809, the BVH builder 801 adds box nodes 806 into the tree of the initial BVH 807. The added box nodes 806 have associated bounding boxes that are smaller than the bounding boxes of the non-divided primitives 804. Moreover, the added box nodes 806 have bounding boxes that bound the opaque primitive portions 704, but not the invisible portions 706. In other words, the added box nodes 806 have bounding boxes that encompass an area that is smaller than the primitives that are divided.

In some implementations, the leaf nodes 804 remain the same as in the initial BVH 807. More specifically, instead of replacing the leaf nodes 804, which point to undivided primitives 700, with leaf nodes that bound only the opaque portions 704, and having the added box nodes 806 point to these replaced leaf nodes, the leaf nodes 804 that correspond to the undivided primitives 700 remain in the refined BVH 809. The added box nodes 806 point to these original leaf nodes 804. It is possible for multiple added box nodes 806 to point to a single such leaf node 804, as illustrated. This occurs because it is possible for the bounding boxes corresponding to the added box nodes 806 to bound an area that is smaller than a particular undivided primitive 700. Because it is possible for multiple such added box nodes 806 to exist in the refined BVH 809 for a single undivided primitive 700, it is possible for the refined BVH 809 to include multiple box nodes 806 to point to the same undivided primitive 700.

The smaller box nodes 806 provide the benefit that a smaller number of any hit shader instances are executed. This occurs because the smaller box nodes 806 result in fewer intersection tests with leaf nodes. More specifically, because the added box nodes 806 do not exist for the invisible portions 706, BVH traversal for a ray that intersects such invisible portions 706 does not reach the leaf node 804 for the undivided primitive 700 corresponding to those invisible portions 706. Keeping the undivided primitives 700 in the refined BVH 809, rather than adding the divided primitives (e.g., opaque primitive portions 704), results in a smaller amount of data being required for the refined BVH 809. The size of the added box nodes is smaller than the divided primitives.

In some implementations, the BVH builder 801 is configured to generate the refined BVH 809 in the following manner. For each box node 802 in the initial BVH 807 that is the parent of a leaf node 804, the BVH builder 801 generates an added bounding box 806 for one or more of the opaque primitive portions 704 of the leaf node 804. The BVH builder 801 sets the parent of each such added bounding box 806 to the box node 802 the is the parent of the leaf node 804. The BVH builder 801 also set the parent of that leaf node 804 to each such added bounding box 806 that corresponds to that leaf node 802. The BVH builder 801 modifies the box node 802 so that the box node 802 is no longer the parent of the leaf node 804.

In the example of FIG. 8, in the initial BVH 807, box 802(7) is the parent of leaf node 804(4). The BVH builder 801 divides the primitive associated with the leaf node 804(4) and obtains two opaque primitive portions 704. The BVH builder 801 determines the bounding boxes for those opaque primitive portions 704, which correspond to added bounding boxes 806(7) and 806(8), and adds those added bounding boxes 806 as children of the box node 802(7). The BVH builder 801 sets the parent of leaf node 804(4) to be both of the added bounding boxes 806(7) and 806(8) rather than box node 802(7).

Although it has been described that an initial bounding box is generated 807 and then converted to a refined bounding box 809, it is also possible for the BVH builder 801 to generate the refined bounding box 809 directly, without first creating an initial bounding box 807. Any such generated BVH 809 would have one or more box nodes 806 having corresponding bounding boxes that bound opaque primitive portions that exclude at least a portion of a primitive of a scene that has is not considered opaque according to an opacity texture. In addition, the generated BVH 809 would include leaf nodes 804 corresponding to the original primitives, where the box nodes 806 point to such leaf nodes 804. In addition, in some instances, multiple of the box nodes 806 of such generated BVH 809 would point to a single such leaf node 804.

During ray tracing, traversal of the refined BVH 809 occurs in a similar manner as described elsewhere herein. For example, a ray tracing pipeline 300 would traverse the BVH nodes, including box nodes and leaf nodes, performing an intersection test for a ray against such nodes. For box nodes, a failed intersection test eliminates children of that box node from consideration. For leaf nodes, the result of the intersection test determines whether the ray intersects the corresponding leaf node. The technique described with respect to FIG. 6, including multiple any hit shader executions, opacity evaluations, and a closest hit shader execution, is still performed. However, a smaller number of any hit shader executions would in general be performed, as compared with a technique that does not eliminate box nodes corresponding to non-opaque portions of a primitive, since bounding box tests would eliminate some of the non-opaque portions of primitives from consideration.

It should be understood that when the phrase “the ray tracing pipeline 300 performs an action” is used, it means that the hardware, software, or combination of hardware and software that implements the ray tracing pipeline 300 performs those steps.

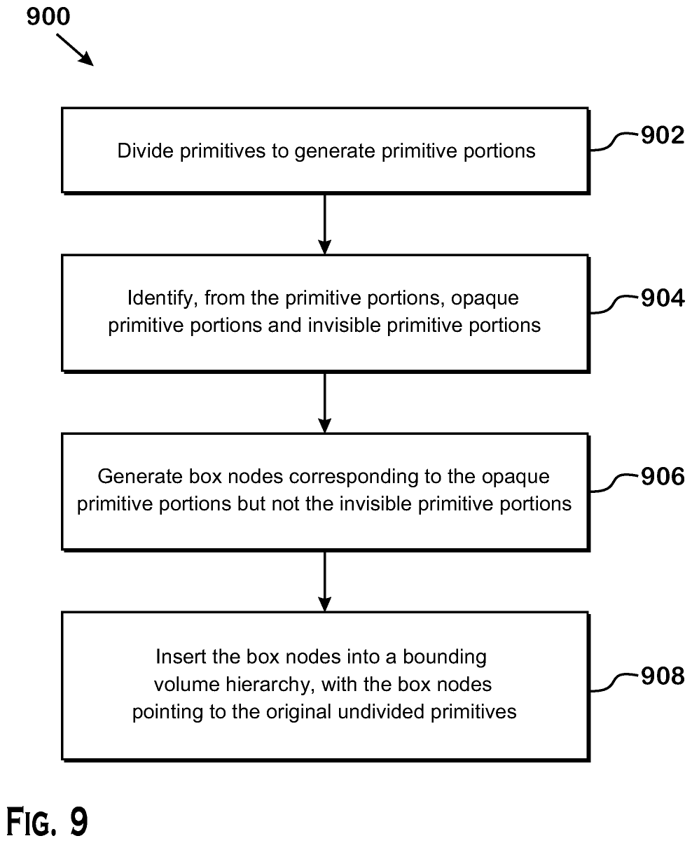

FIG. 9 is a flow diagram of a method 900 for performing ray tracing operations, according to an example. Although described with respect to the system of FIGS. 1-8, those of skill in the art will recognize that any system configured to perform the steps of the method 900 in any technically feasible order falls within the scope of the present disclosure.

The method 900 begins at step 902, where a BVH builder 801 divides one or more primitives of a scene to generate primitive portions. The primitives that are divided are designated as having an associated opacity texture.

At step 904, the BVH builder 801 identifies, from the primitive portions, opaque primitive portions, and invisible primitive portions. Opaque primitive portions are portions designated as opaque by the opacity texture. Invisible primitive portions are portions designed as invisible by the opacity texture.

At step 906, the BVH builder 801 generates box nodes corresponding to the opaque primitive portions but not the invisible primitive portions. In an example, the BVH builder 801 generates one box node for each primitive portion. The box nodes generated in this manner are assigned a bounding box that bounds the corresponding opaque primitive portion.

At step 908, the BVH builder 801 inserts the generated box nodes into a bounding volume hierarchy, with the box nodes being the parent of the leaf node corresponding to the original undivided primitive. In some examples, the BVH builder 801 modifies the box node that pointed to the primitive to instead point to one or more box nodes generated based on that primitive. In addition, in some examples, the BVH builder 801 modifies the box node that pointed to the primitive to no longer point to that primitive.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for performing ray tracing operations, the method comprising:
dividing a primitive of a scene to generate primitive portions;
identifying, from the primitive portions, and based on an opacity texture, one or more opaque primitive portions and one or more invisible primitive portions;
generating box nodes for a bounding volume hierarchy, wherein the box nodes enclose the opaque primitive portions and do not enclose the invisible primitive portions; and
inserting the generated box nodes into the bounding volume hierarchy.

2. The method of claim 1, wherein:
the generated box nodes are inserted into the bounding volume hierarchy, with the box nodes pointing to the primitive.

3. The method of claim 1, wherein the one or more opaque portions are portions of the primitive indicated as being opaque by the opacity texture.

4. The method of claim 1, wherein:
generating the box nodes comprises generating box nodes including bounding boxes, wherein each bounding box bounds a different opaque primitive portion.

5. The method of claim 4, wherein the bounding boxes of the box nodes generated from the primitive bound a smaller volume than a bounding area for the primitive.

6. The method of claim 1, wherein the primitive portions occupy the same area as the primitive.

7. The method of claim 1, further comprising:
performing a ray tracing operation using the bounding volume hierarchy.

8. The method of claim 7, wherein performing the ray tracing operation comprises executing a plurality of any hit shaders, and evaluating opacity for each such executed any hit shaders.

9. The method of claim 8, wherein performing the ray tracing operation further comprises executing a closest hit shader to determine the closest hit to an opaque portion of the primitive.

10. A device for performing ray tracing operations, the device comprising:
a memory storing a bounding volume hierarchy; and
a bounding volume hierarchy builder configured to:
divide a primitive of a scene to generate primitive portions;
identify, from the primitive portions, and based on an opacity texture, one or more opaque primitive portions and one or more invisible primitive portions;
generate box nodes for the bounding volume hierarchy, wherein the box nodes enclose the opaque primitive portions and do not enclose the invisible primitive portions; and
insert the generated box nodes into the bounding volume hierarchy.

11. The device of claim 10, wherein:
the generated box nodes are inserted into the bounding volume hierarchy, with the box nodes pointing to the primitive.

12. The device of claim 10, wherein the one or more opaque portions are portions of the primitive indicated as being opaque by the opacity texture.

13. The device of claim 10, wherein:
generating the box nodes comprises generating box nodes including bounding boxes, wherein each bounding box bounds a different opaque primitive portion.

14. The device of claim 13, wherein the bounding boxes of the box nodes generated from the primitive bound a smaller volume than a bounding area for the primitive.

15. The device of claim 10, wherein the primitive portions occupy the same area as the primitive.

16. The device of claim 10, wherein the BVH builder is further configured to:
perform a ray tracing operation using the bounding volume hierarchy.

17. The device of claim 16, wherein performing the ray tracing operation comprises executing a plurality of any hit shaders, and evaluating opacity for each such executed any hit shaders.

18. The device of claim 17, wherein performing the ray tracing operation further comprises executing a closest hit shader to determine the closest hit to an opaque portion of the primitive.

19. A non-transitory computer-readable medium storing instruction that, when executed by a processor, cause the processor to:
divide a primitive of a scene to generate primitive portions;
identify, from the primitive portions, and based on an opacity texture, one or more opaque primitive portions and one or more invisible primitive portions;
generate box nodes for the bounding volume hierarchy, wherein the box nodes enclose the opaque primitive portions and do not enclose the invisible primitive portions; and
insert the generated box nodes into the bounding volume hierarchy.

20. The non-transitory computer-readable medium of claim 19, wherein:
the generated box nodes are inserted into the bounding volume hierarchy, with the box nodes pointing to the primitive.
